(19) United States
(12) Patent Application Publication
(10) Pub. No.: US 2004/0163826 A1
(43) Pub. Date: Aug. 26, 2004

(54) Fire protection systems and methods

(76) Inventor: David John Spring, Slough (GB)

Correspondence Address: MERCHANT & GOULD PC, P.O. BOX 2903, MINNEAPOLIS, MN, 55402-0903, US

(21) Appl. No.: 10/473,832

(22) PCT Filed: Apr. 2, 2002
(86) PCT No.: PCT/GB02/01531

(30) Foreign Application Priority Data
Apr. 4, 2001 (GB) 0108512.5

(51) Int. Cl. A62C 35/00

(52) U.S. Cl. 169/46; 169/9; 169/5; 169/62; 169/14

(57) ABSTRACT

Air from an air source A, which may be the bleed air of an aircraft, enters the system under the control of an air flow control unit (10). An organic fuel from a fuel reservoir (12 or 13) enters a mixing chamber (16) under the control of fuel flow control unit (14) for mixture with the air. At a first stage the organic fuel is a oxygenated organic fuel from reservoir (12), and at a subsequent stage the organic fuel is a hydrocarbon fuel from reservoir (13). The air and fuel mixture passes to a catalyst bed (18) containing a noble metal catalyst such as platinum, palladium or a mixture thereof. A relatively low temperature, non-flaming reaction occurs and the resultant gas mixture contains a low concentration of oxygen and larger qualities of inert gases such as nitrogen, carbon dioxide and water vapour. This post reaction mixture, which leaves the system at B, is suitable for suppressing and extinguishing fires, and is especially suitable for purging of air from cargo compartments on board aircraft during a flight on detection of a fire. A temperature control unit (20) associated with the catalyst bed (18) may be used to prevent its overheating during the reaction. A control unit (24) operates to control the air flow control unit (10), the fuel flow control unit (14) and the temperature control unit (20) in response to signals from sensing units (22) at various points in the system which detect various parameters such as the gas, pressure, temperature and flow.

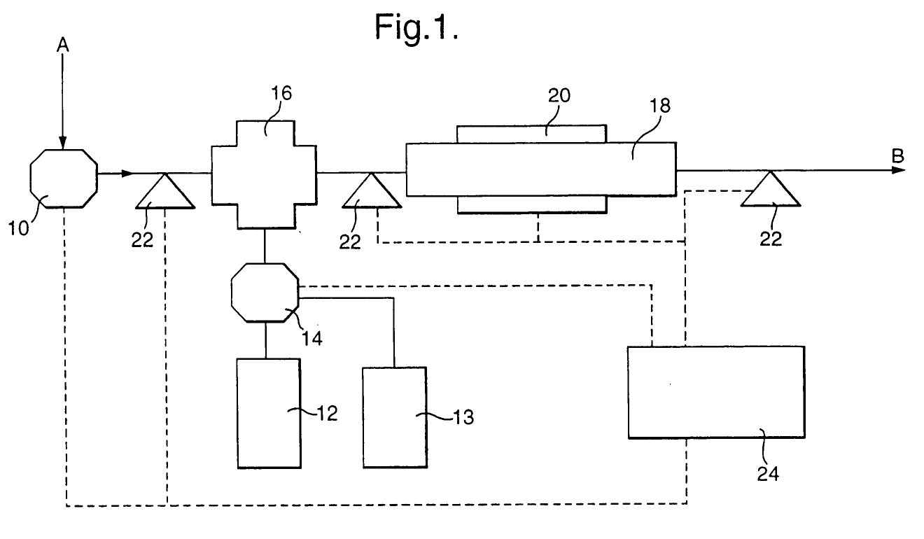

### TECHNICAL FIELD

The invention relates to fire protection systems and methods. Fire protection systems and methods according to the invention and to be described in more detail below, by way of example only, are particularly suitable for use in conditions where weight and size may present problems, such as on board aircraft or on other vehicles.

### BACKGROUND ART

One method of suppressing or extinguishing a fire is to surround it with an inert atmosphere. This type of fire protection method is best suited to an enclosed space, where the air within is at least partly displaced by the inert atmosphere. The inert atmosphere could be produced using an inert gas or gases stored under pressure in cylinders, ready for deployment into the enclosed space when required. However, such cylinders are not appropriate where the weight and bulk of the fire protection system is to be minimised such as, for example, on board aircraft where space is limited and heavy components mean that less load can be carried.

GB-A-1395691 discloses an aircraft fuel tank inerting system comprising a catalytic reactor that reacts fuel and air, and a conduit for supplying the reaction gases to the fuel tank.

### DISCLOSURE OF THE INVENTION

According to the invention, there is provided a fire or explosion protection system, comprising inert gas producing means operative to produce an inert gas output (B) using low temperature catalytic oxidation of organic fuel, and means operative to deploy the inert gas output into a region to be protected against the fire or explosion, wherein the inert gas producing means comprises mising means operative to mix air (A) with the organic fuel and means operative to pass the resultant mixture over a noble metal catalyst, characterised in that the mixing means is operative in a first stage to mix the air (A) with organic fuel in the form of an oxygenated organic fuel and being operative in a second stage to mix the air (A) with organic fuel in the form of a hydrocarbon fuel whereby to produce the inert gas when the resultant mixture is passed over the heated catalyst.

According to the invention, there is further provided a method of protecting a region from fire or explosion, comprising the steps of mixing air from an air source (A) with organic fuel from an organic fuel source, passing the mixture over a catalyst for a low temperature oxidation reaction to produce an inert gas output (B), and passing the resultant inert gas output (B) into the region to be protected, characterised in that the mixing step comprises a first stage in which the fuel is an oxygenated organic fuel, and a second stage in which the fuel is a hydrocarbon.

### BRIEF DESCRIPTION OF THE DRAWING

The accompanying drawing is a schematic block diagram of a fire protection system according to the invention. Fire protection systems and methods according to the invention such as for use on board aircraft will now be described, by way of example only, with reference to the accompanying drawing.

### MODE OF CARRYING OUT THE INVENTION

The systems to be described generate inert gas in relatively large quantities and are of low weight and small size. They are therefore particularly suitable for use on board aircraft where weight and size are significant factors to be taken into account. However, they can be used in any other applications such as where low weight and small size are desirable, such as in other vehicles (military vehicles, for example).

In aircraft, the systems to be described are particularly suitable for suppressing or preventing fires or explosions in fuel tanks and cargo bays which present enclosed spaces (though not completely sealed), into which the inert atmosphere can be deployed.

In the case of aircraft fuel tanks, the size of the ullage space will clearly vary (increase) during flight, and the atmosphere within the ullage space will also vary during flight, changing its pressure and temperature as the aircraft climbs or descends. The atmosphere in the ullage space will also change its composition as decreases in the ambient pressure cause dissolved gas in the liquid fuel to come out of solution, particularly oxygen which is more soluble in hydrocarbons than nitrogen. Therefore, the flammability of the atmosphere within the ullage space will vary during flight. For this reason, it is not practicable simply to fill the ullage space in the fuel tank with an inert atmosphere before take-off. It is therefore desirable to have on board the aircraft a system for producing inert gas during flight so that the desired quantity of inert gas can be fed into the tank ullage space according to the changing conditions there.

In the case of aircraft cargo bays, they are normally pressurised in substantially the same way as the aircraft passenger cabin, particularly because they are normally designed to carry livestock, and a flow of air is therefore arranged to enter the compartment throughout the flight. In the event of a fire in the cargo bay during flight, a fire extinguishant will be deployed into the cargo bay, such as Halon or a water spray. However, although this may extinguish the immediate fire, it may be impossible to prevent continual smouldering in the cargo bay because of the nature of the materials (passenger luggage in particular) which will be carried. Deployment of an inert atmosphere into the cargo bay is thus a very effective way of preventing or at least controlling such smouldering until the aircraft can reach a safe landing. Again, therefore, a means of generating an inert atmosphere on board the aircraft during flight is required.

The system shown in the FIGURE comprises an air flow control unit 10, a first fuel reservoir 12, a second fuel reservoir 13, a fuel flow control unit 14, a mixing chamber 16, a catalyst bed 18 with an associated temperature control unit 20, sensor units 22, and a control unit 24.

Air enters the system from a source A at ambient or slightly elevated pressures, under the control of the air flow control unit 10. Fuel passes from either the first reservoir 12 or the second reservoir 13 under the control of the fuel flow control unit 14 into the mixing chamber 16 where it mixes with the air from the air flow control unit 10 (to be described in more detail below). The air and fuel mixture then passes from the mixing chamber 16 over the catalyst bed 18 for reaction with a catalyst (also to be described in more detail below). The resultant inert gas mixture passes out of the system at B whence it can be fed into the ullage space of an aircraft fuel tank or into an aircraft cargo bay.

Preferably, the fuel in the first reservoir 12 is an oxygenated organic material such as methanol, CH₃OH, or ethanol, C₂H₅OH, or a mixture thereof. Such fuels react on the catalyst without preheating of the catalyst bed 18. The fuel in the second reservoir 13 can be a gaseous or liquid hydrocarbon such as a heptane or gasoline or aviation kerosene. With such fuels it is necessary to preheat the catalyst bed 18 to 400-500° C. to initiate a reaction.

Initially oxygenated organic material as described is used from the first reservoir 12, followed by a hydrocarbon fuel as described from the second reservoir 13, once the catalyst has been heated sufficiently through the reaction with the oxygenated organic fuel. The advantage of this approach is that hydrocarbon fuels remove more oxygen per unit mass then oxygenated organic fuels and are therefore more weight-efficient. This is, of course, an important consideration for a system for use on board an aircraft.

The hydrocarbon fuel is preferably supplied from the aircraft's primary fuel supply, i.e. the fuel supply for the aircraft engines. In this instance the second reservoir 13 would be the (or one of) the aircraft's conventional fuel tanks. This is advantageous because no additional tank for the hydrocarbon fuel for the system is required, reducing the overall weight of the system.

The fuel can be mixed with the air flow from the source A in the mixing chamber 16 by any suitable means, such as by passing the air through liquid fuel so as to saturate the air with fuel vapour, or by spraying liquid fuel under pressure into the air stream at such a temperature that it all evaporates; the fuel may be metered into the air stream under the control of the fuel flow control unit 14 by any convenient means such as an electric pump or under stored gas pressure. A convenient source of air A on board an aircraft is the bleed air of the aircraft. Its flow into the system is regulated by the air flow control unit 10. It will be appreciated that the source of air A could comprise any suitable source and is not limited to the bleed air of the aircraft.

The following oxidation reaction occurs on the catalyst bed 18 if methanol is the fuel:

CH₃OH+1½O₂+5.67N₂→CO₂+2H₂O+5.67N₂

This results in a gas mixture of composition 11.5 vol % CO₂, 65.4 vol % N₂ and 23.1 vol % H₂O. Thus the oxygen in the air from source A is replaced with gases such as carbon dioxide and water vapour which do not support combustion and which, furthermore, result in an enhancement of the extinguishing performance of the mixture as compared with pure nitrogen. It is this gas mixture that is produced at the output B. The system will produce inert gases as long as it has fuel and air. The methanol fuel is a liquid and preferably is stored in a pressurised storage container.

The catalyst on the catalyst bed 18 requires high thermal stability, mechanical strength and resistance to any poisons found in the fuel. It may be any metal from Group VIII of the Periodic Table, such as platinum, palladium, rhodium or iridium. These materials could alternatively be used in the form of their most active oxides. Preferably the catalyst comprises substantially platinum or palladium, or mixtures, since the reaction with the incoming air and fuel mixture from the mixing chamber 16 will start without preheating of the incoming mixture.

The catalyst may comprise fine metal particles (for example in the range 3-20 nm) disposed on an inert mineral-based support. This type of support may comprise alumina or aluminosilicates in fibrous or crystalline form, or porous granules or a honeycomb monolithic structure made from alumina, alumina/silica combinations or other inert oxides. The support is structured so as not to impede gas flow through the catalyst bed 18 but to maintain a sufficient contact time between the reactants (the incoming air and fuel mixture from the mixing chamber 16) and the catalytic surface.

The temperature control unit 20 may be necessary to prevent overheating of the catalyst bed 18 due to the heat generated by the reaction, because the efficiency of the catalyst may deteriorate with overheating. For example, the catalyst temperature should be kept below 1000° C. to prevent sintering whereby the catalyst particles would fuse together. The temperatures generated by the reaction are considerably less than those generated by flaming combustion, which are typically greater than 1500° C., because the reaction occurs at the catalyst surface and there is no flame. The temperature control unit 20 may also be used to preheat the catalyst bed 18 should this be necessary to start a reaction.

The system operates under the control of the control unit 24, which receives feedback from the sensor units 22, each of which can sense gas, pressure, temperature and flow. There is one sensor unit 22 located between the air flow control unit 10 and the mixing chamber 16, another located between the mixing chamber 16 and the catalyst bed 18, and a third located downstream of the catalyst bed 18. The control unit 24 operates to control the air flow control unit 10, the fuel flow control unit 14 and the temperature control unit 20 in response to the feedback from the sensor units 22 to ensure that the system is working efficiently and safely and the gas concentrations leaving at B are within specified ranges. It is important that the fuel concentration in the air is kept on the lean side of stoichiometric, because if the mixture from the mixing chamber 16 becomes rich, the exhaust from the catalyst bed 18 at B will contain significant quantities of unreacted fuel and of carbon monoxide. The latter is especially undesirable because of the possibility of back leakage of gases from the cargo compartment into the passenger compartment.

The control unit 24 controls, by fuel flow control unit 14, from which of the first 12 and second 13 reservoirs fuel is supplied. The control unit 24 may switch the supply of fuel to the mixing chamber 16 from the first reservoir 12 to the second reservoir 13 when it receives an indication from temperature control unit 20 that the catalyst is sufficiently heated to allow a reaction to occur with the hydrocarbon fuel stored in the second reservoir 13.

Alternatively, the control means will switch the fuel supply from the first reservoir 12 to the second reservoir 13 when it receives an indication that only a predetermined quantity of fuel remains in the first reservoir 12. An indication to switch reservoirs is preferably given when the reservoir 12 is substantially empty. That the reservoir 12 is empty may be determined by a liquid level sensor, by a timer (indicating the period over which fluid has been supplied from the first reservoir 12) or a flow sensor (a reduced flow rate indicating that the fuel is running out). It may be advantageous to empty the reservoir 12 because, firstly, the organic fuel has a relatively low flash point—so is, itself, hazardous to store, and, secondly, the weight burden of stored fuels would be reduced. With such an arrangement, the amount of stored organic fuel will preferably be just sufficient to heat the catalyst to the desired temperature.

It will be appreciated that the control unit 24 could also control the fire detection means and the fire protection system used to provide the initial knockdown of the fire.

The air and fuel need not be mixed in a mixing chamber. There may be more than three sensor units in the system; each sensor unit may sense different parameters.

In the case of aircraft fuel tanks, the inert gases produced at the output B may be deployed into the ullage space in controlled amounts during flight according to the changing conditions of pressure and temperature within the fuel tank and the fuel usage. This deployment can be automatic under control of suitable sensors. In this case, therefore, the deployment of the inert gases is purely for prevention purposes and does not rely on detection of a fire or explosion.

In the case of an aircraft cargo bay, deployment of the inert gases into the cargo bay will normally occur in response to detection of an actual fire by means of suitable fire detectors within the cargo bay. In response to the initial detection of the fire, a fire knock down system will be activated for quickly suppressing the fire. This system may take any suitable form, such as using a rapid discharge of Halon or a Halon replacement agent or a water spray system. This will then be followed by deployment of the inert gases into the cargo bay, at the same time shutting off the normal air flow into the cargo bay. The inert gases will need to be supplied constantly in order to compensate for any leakage of air into the compartment or leakage of inert gas from the compartment.

In either case, the inert gases need not be generated at the region to be protected. The catalyst bed 18 of the invention may be located at a point remote from the region to be protected, the resultant inert gas mixture being passed through ducting to the region. One suitable location for the catalyst bed 18 is in an auxiliary power unit (APU) compartment, because such compartments are usually located outside the fire wall and the pressure shell of the aircraft, and are themselves fire-protected. Locating the catalyst bed 18 remote from the region to be protected reduces the risk associated with having the fuel source 12 close to the region.

Although the systems described are particularly suitable, because of their low weight and small size, for fire protection purposes on board aircraft, they are not limited to such applications. They may be used in any other applications for fire or explosion purposes, particularly where low weight and/or small size are desired, such as on board other vehicles such as military vehicles, trucks or railway trains for example. Their low weight and small size makes them advantageous over other methods of generating inert gas outputs, such as pyrotechnic inert gas generators and air separation techniques. The former are a very high density storage medium and are able to generate large amounts of inert gas very rapidly. However, the pyrotechnic nature of the reaction to generate the gas and the hot gases produced render this method unsuitable for many applications, particularly on board aircraft. The latter, including adsorptive gas separation such as pressure swing adsorption (PSA) over molecular sieves, selective permeation through polymer membranes, and cryogenic fractionation of liquid air involve the use of high pressures and complicated machinery, which is very heavy and therefore not desirable for use in many applications, again particularly on board aircraft.

1. A fire or explosion protection system, comprising inert gas producing means operative to produce an inert gas output (B) using low temperature catalytic oxidation of organic fuel, and means operative to deploy the inert gas output into a region to be protected against the fire or explosion, wherein the inert gas producing means comprises mixing means (16) operative to mix air (A) with the organic fuel and means operative to pass the resultant mixture over a noble metal catalyst (18), characterised in that the mixing means (16) operative in a first stage to mix the air (A) with organic fuel in the form of an oxygenated organic fuel (12) and being operative in a second stage to mix the air (A) with organic fuel in the form of a hydrocarbon fuel (13) whereby to produce the inert gas when the resultant mixture is passed over the heated catalyst (18).

2. A fire or explosion protection system according to claim 1, wherein the oxygenated organic fuel and/or the hydrocarbon fuel is a liquid.

3. A fire or explosion protection system according to claim 1 or 2, wherein the oxygenated organic fuel (12) comprises methanol and/or ethanol.

4. A fire or explosion protection system according to claim 1, 2 or 3, wherein the hydrocarbon fuel (13) is kerosene.

5. A fire or explosion protection system according to any one of claims 1 to 4, including means (24) for rendering the mixing means (16) operative in the second stage when the catalyst (18) has reached a predetermined temperature.

6. A fire or explosion protection system according to any one of claims 1 to 4, including means (24) for rendering the mixing means (16) operative in the second stage, the means being responsive to an indication that a predetermined quantity of the oxygenated organic fuel is present in a reservoir thereof.

7. A fire or explosion protection system according to claim 6, wherein said predetermined quantity is selected to be indicative of the reservoir being empty.

8. A fire or explosion protection system according to any one of claims 1 to 7 wherein the catalyst (18) is from Group VIII of the Periodic Table.

9. A fire or explosion protection system according to claim 8, wherein the catalyst (18) is substantially platinum.

10. A fire or explosion protection system according to claim 8, wherein the catalyst (18) is substantially palladium.

11. A fire or explosion protection system according to claim 8, wherein the catalyst (18) is substantially a mixture of platinum or palladium.

12. A fire or explosion protection system according to any one of claims 1 to 11, wherein the catalyst (18) is contained in a catalyst bed.

13. A fire or explosion protection system according to any preceding claim, wherein the region is an enclosed space.

14. A fire or explosion protection system according to claim 13, wherein the region is on board an aircraft.

15. A fire or explosion protection system according to claim 14, wherein the enclosed space is the ullage space of a fuel tank.

16. A fire or explosion protection system according to claim 14, wherein the enclosed space is a cargo compartment.

17. A fire or explosion protection system according to any one of claims 14 to 16, wherein the air is the bleed air of the aircraft.

18. A fire or explosion protection system according to any one of claims 14 to 17, wherein the hydrocarbon fuel (13) is provided from the aircraft primary fuel supply.

19. A fire or explosion protection system according to any preceding claim, wherein the inert gas producing means is located remote from the region to be protected.

20. A method of protecting a region from fire or explosion, comprising the steps of mixing air from an air source (A) with organic fuel from an organic fuel source, passing the mixture over a catalyst (18) for a low temperature oxidation reaction to produce an inert gas output (B), and passing the resultant inert gas output (B) into the region to be protected, characterised in that the mixing step comprises a first stage in which the fuel is an oxygenated organic fuel (12), and a second stage in which the fuel is a hydrocarbon (13).

21. A method of protecting a region from fire or explosion according to claim 20, wherein the oxygenated organic fuel and/or the hydrocarbon fuel is liquid.

22. A method of protecting a region from fire or explosion according to claim 20 or 21, wherein the fuel (12) in the first stage comprises methanol and/or ethanol.

23. A method of protecting a region from fire or explosion according to claim 20, 21 or 22, wherein the hydrocarbon fuel (13) is kerosene.

24. A method of protecting a region from fire or explosion according to any one of claims 20 to 23, wherein the second stage begins when the catalyst (18) has reached a specified temperature.

25. A method of protecting a region from fire or explosion according to any one of claims 20 to 24, wherein the second stage begins in response to an indication that a predetermined quantity of oxygenated organic fuel is present in a reservoir thereof.

26. A method of protecting a region from fire or explosion according to claim 25, wherein the predetermined quantity is selected to be indicative of the reservoir being empty.

27. A method of protecting a region from fire or explosion according to any one of claims 20 to 26, wherein the catalyst (18) is from Group VIII of the Periodic Table.

28. A method of protecting a region from fire or explosion according to claim 27, wherein the catalyst (18) is substantially platinum.

29. A method of protecting a region from fire or explosion according to claim 27, wherein the catalyst (18) is substantially palladium.

30. A method of protecting a region from fire or explosion according to claim 27, wherein the catalyst (18) is substantially a mixture of platinum or palladium.

31 A method of protecting a region from fire or explosion according to any one of claims 20 to 30, wherein the catalyst (18) is contained in a catalyst bed.

32. A method of protecting a region from fire or explosion according to any one of claims 20 to 31, wherein the region is an enclosed space.

33. A method of protecting a region from fire or explosion according to claim 32, wherein the region is on board an aircraft.

34. A method of protecting a region from fire or explosion according to claim 33, wherein the enclosed space is the ullage space of a fuel tank.

35. A method of protecting a region from fire or explosion according to claim 33, wherein the enclosed space is a cargo compartment.

36. A method of protecting a region from fire or explosion according to claims 33 to 35, wherein the air source is the bleed air of the aircraft.

37. A method of protecting a region from fire or explosion according to any one of claims 33 to 26, wherein the hydrocarbon fuel is provided from the aircraft primary fuel supply.

38. A method of protecting a region from fire or explosion according to any one of claims 20 to 36, including the steps of controlling the air source (A) by means of an air flow control unit (10), and controlling the fuel source by means of a fuel flow control unit (14).

39. A method of protecting a region from fire or explosion according to claim 38, wherein each of the air flow control unit (10) and the fuel flow control unit (14) is under the control of a control unit (24).

40. A method of protecting a region from fire or explosion according to any one of claims 20 to 39, including the step of controlling the temperature of the catalyst (18) by means of a temperature control unit (20).

41. A method of protecting a region from fire or explosion according to claim 40, wherein the temperature control unit (20) is under the control of a control unit (24).

42. A method of protecting a region from fire or explosion according to claim 41 when dependent on claim 31, wherein the control unit (24) also controls the air flow control unit (10) and the fuel flow control unit (14).

43. A method of protecting a region from fire or explosion according to any one of claims 38 to 42, further including the steps of sensing various parameters of the gases in the mixture including the gas, pressure, temperature and flow, at points prior to mixing, post mixing and post reaction, the air flow unit, the fuel flow unit and the temperature control unit operating in response to the detected parameters.

44. A method of protecting a region from fire or explosion according to any one of claims 20 to 43, including the step of knocking down the fire by another method prior to passing the generated inert gas mixture into the region to be protected.

45. A method of protecting a region from fire or explosion according to claim 44, wherein the knocking down step is controlled by the control unit (24) of claim 42.

46. A method of protecting a region from fire or explosion according to claim 42, wherein the step of detecting the fire is under the control of the control unit (24).
